(19) United States
(12) Patent Application Publication
(10) Pub. No.: US 2026/0017624 A1
(43) Pub. Date: Jan. 15, 2026

(54) METHODS FOR CROSS-SERVICE PROVIDER ONLINE PAYMENT

(71) Applicant: TBCASOFT, INC., Sunnyvale, CA (US)

(72) Inventors: Ling WU, San Jose, CA (US); Kaidi DU, Santa Clara, CA (US)

(21) Appl. No.: 19/134,763

(22) PCT Filed: Dec. 4, 2023
(86) PCT No.: PCT/US23/82387

§ 371 Date: Jun. 2, 2025

Related U.S. Application Data
(60) Provisional application No. 63/385,946, filed on Dec. 2, 2022.

(51) Int. Cl. G06Q 20/02; G06Q 20/32

(52) U.S. Cl. CPC G06Q 20/02; G06Q 20/3274

(57) ABSTRACT

The present invention relates to methods for online checkout between an issuer system of a selected issuer and an acquirer system of an acquirer using mobile payment. An online merchant of an acquirer may provide a URL to request the payment from a payer of an issuer different from the acquirer. The URL is configured to instruct a user device of the payer to receive an issuer list comprising multiple mobile payment service providers, so that the payer may select one from the list as the issuer to pay. Then the URL may instruct the selected issuer to automatically process following steps to deliver the payment from the issuer to the acquirer.

### RELATED APPLICATION

This application claims the benefit of the U.S. Provisional Application No. 63/385,946 filed on Dec. 2, 2022, titled “A METHOD FOR IMPROVING ONLINE QR CODE PAYMENT,” which is incorporated herein by reference at its entirety.

### BACKGROUND OF THE INVENTION

### Field of the Invention

The present invention relates to methods to facilitate cross-service provider online payment, especially for two mobile payment service providers (MPSPs) with different transaction QR-code formats.

### Description of Related Art

In recent years, mobile payment has become a popular payment method as it can be easily done and requires only a mobile device for the payer. Among all mobile payment routes, QR code scanning is probably the most widely used one for a consumer to buy things at a merchant's place.

Besides traditional merchant stores, more and more merchants make their products available online thanks to the development of E-commerce. Therefore, there is an increasing need for mobile payment in E-commerce. To request and receive a payment, the webpage of an online merchant may show a QR code on the checkout page, or it may also redirect the consumer to login his or her mobile payment account to proceed with the payment. The consumer then may transfer the payment to the merchant account, providing that both the consumer account and the merchant account belong to the same mobile payment service provider (MPSP).

In both the above cases, the online merchant may only receipt payment from limited number of mobile payment service providers (MPSPs). If the consumer does not install any apps of the accepting MPSPs, he or she may not be able to use mobile payment to purchase goods or service from the online merchant. This is especially the case if the consumer purchases goods or service on a foreign website, because many MPSPs only provide service locally and do not operate overseas. To deal with this problem, some mobile payment service providers may accept cross-MPSP transactions (also called bridging transactions) by having bilateral agreements with other service providers and modify their systems accordingly, so that they may be able to accept payments from other service providers.

However, some problems may still arise even with the above improvement. Firstly, having bilateral agreements with many MPSPs and amending the systems accordingly is troublesome and time consuming. A service provider needs to amend its system every time when a new cooperative partner joins its payment network. Another problem is when a consumer utilizes a portable device (e.g. a smartphone) to browse the webpage of an online store and checkout. A portable device cannot physically scan a QR code on the web checkout page displayed on the portable device's own screen. It is quite inconvenient for a consumer to take a screenshot first, and use another app to “scan” the QR code by uploading the screenshot to the app in order to proceed with the payment. The situation may be even more complicated if the transaction is a cross-MPSP transaction (bridging transaction). Even if a cross-MPSP agreement applies, it is still difficult to perform cross-MPSP transactions online, for the QR code or the link on the checkout page might not be able to direct the consumer to the payment confirmation page of the MPSP selected by the consumer.

Therefore, it is still a need to develop new methods to facilitate cross-MPSP online payment.

### SUMMARY OF THE INVENTION

Provided herein is a method for online checkout between an issuer system of a selected issuer and an acquirer system of an acquirer using mobile payment. The method of the present application applies when a consumer (a payer) wants to purchase goods or services in an online merchant with mobile payment. There may be many mobile payment service providers (MPSPs) available in a payment network, wherein different MPSPs in the network are linked together by a bridging service provider. The payer may select an MPSP in the network as the issuer to deliver the payment, and the online merchant may select another MPSP in the network as the acquirer to receive the payment.

After the payer decided to checkout, the online merchant may provide a checkout URL (which may also be embedded in a merchant QR code) for the payer to pay. Since there may be many MPSPs available as the issuer, before processing the payment a user device of the payer may request an issuer list comprising one or more available issuers for the payer to select. The selected issuer should be different from the acquirer, since the bridging service provider is not required for two members of the same MPSP. The checkout URL may be configured to instruct the user device to generate a delivery request for the payment. Thus, the delivery request may be generated based on the checkout URL, and may request a delivery transaction to the acquirer system of the acquirer. In some embodiments, the user device is a portable device, and the checkout URL is configured to open issuer apps of the one or more available issuers installed on the portable device.

From the perspective of a bridging system of the bridging service provider, the method for online checkout comprises steps of: (1) providing an issuer list comprising one or more available issuers to a user device of a payer, and (2) receiving a delivery request from the issuer system of the selected issuer selected from the one or more available issuers.

Before providing the issuer list comprising one or more available issuers, the method may further comprise the step of receiving a list request from the user device of the payer. The list request may be received from the payer's user device, or it may be redirected from the acquirer system. In the case where the list request is received directly from the payer's user device, the checkout URL may be configured to direct the user device to the bridging system, and the checkout URL may be embedded in a QR code of the bridging service provider. In another case where the list request is redirected from the acquirer system, the checkout URL may be configured to direct the user device to the acquirer system, and the checkout URL may be embedded in a QR code of the acquirer.

After receiving the delivery request from the issuer system, the method for online checkout may further comprise the following steps to complete the transaction: (1) providing the delivery request to the acquirer system, (2) receiving a payment request from the acquirer system, (3) providing the payment request to the issuer system, (4) receiving a payment confirmation confirming the payment request from the issuer system, and (5) providing the payment confirmation to the acquirer system.

From the perspective of the user device of the payer, the method for online checkout comprises steps of: (1) receiving an issuer list comprising one or more available issuers for the payer to select, and (2) providing a delivery request to the issuer system of the selected issuer selected from the one or more available issuers. Before providing the issuer list comprising one or more available issuers, the method may further comprise the step of providing a list request by the user device.

There are at least three different embodiments of providing and receiving the issuer list. In the first embodiment, the list request is provided to the bridging system of the bridging service provider, and the issuer list is also received from the bridging system. In the second embodiment, the list request is provided to the acquirer system of the acquirer, and the issuer list is also received from the acquirer system. In the third embodiment, the list request is provided to the acquirer system, but the list request is redirected form the acquirer system to the bridging system, and so the issuer list is received from the bridging system.

In the case where the list request is provided to the bridging system, the checkout URL may be configured to direct the user device to the bridging system, and the checkout URL may be embedded in a QR code of the bridging service provider. In another case where the list request is provided by the acquirer system, the checkout URL may be configured to direct the user device to the acquirer system, and the checkout URL may be embedded in a QR code of the acquirer.

After providing the delivery request to the issuer system, the method for online checkout may further comprise the following steps to complete the transaction: (1) receiving a payment request from the issuer system, and (2) providing a payment confirmation confirming the payment request to the issuer system.

From the perspective of the issuer system of the selected issuer, the method for online checkout comprises steps of: (1) receiving a delivery request from a user device of a payer, and (2) providing the delivery request to a bridging system of a bridging service provider. Since the checkout URL may be resolve by the bridging system or the acquirer system, the issuer system may not resolve the payment request embedded in the checkout URL.

After providing the delivery request to the bridging system, the method for online checkout may further comprise the following steps to complete the transaction: (1) receiving a payment request from the bridging system, (2) providing the payment request to the user device, (3) receiving a payment confirmation confirming the payment request from the user device, and (4) providing the payment confirmation to the bridging system.

From the perspective of the acquirer system of the acquirer, the method for online checkout may comprise a step of returning an issuer list directly to the user device after the acquirer system receiving the list request, or it may comprise a step of redirecting the user device to the bridging system after the acquirer system receiving the list request. For the first case, the method comprises steps of: (1) receiving a list request from a user device of a payer, (2) providing an issuer list comprising one or more available issuers to the user device of the payer, and (3) receiving a delivery request from an issuer system of the selected issuer via the bridging system, wherein the selected issuer is selected from the one or more available issuers. For the second case, the method comprises steps of: (1) receiving a list request from a user device of a payer, (2) redirecting the user device to a bridging system of a bridging service provider, so that the bridging system provides providing an issuer list comprising one or more available issuers to the user device, and (3) receiving a delivery request from an issuer system of the selected issuer via the bridging system, wherein the selected issuer is selected from the one or more available issuers. In both cases, the checkout URL may be configured to direct the user device to the acquirer system, and the checkout URL may be embedded in a QR code of the acquirer.

After receiving the delivery request from the issuer system, the method for online checkout may further comprise the following steps to complete the transaction: (1) providing a payment request to the bridging system, and (2) receiving a payment confirmation confirming the payment request from the bridging system.

Other objectives, advantages and novel features of the invention will become more apparent from the following detailed description when taken in conjunction with the accompanying drawings.

### BRIEF DESCRIPTION OF THE DRAWINGS

FIG. 1 shows a network of 6 MPSPs having cross-MPSP bilateral agreements with each other.

FIG. 2 shows a network of 6 MPSPs having cross-MPSP bilateral agreements independently with a bridging service provider.

FIG. 3 shows a flow chart of the first embodiment enabling seamless online checkout with cross-MPSP mobile payment. In this embodiment, the bridging system of the bridging service provider receives a list request from a user device of the payer, and returns an issuer list to the user device.

FIG. 4 shows a flow chart of the second embodiment enabling seamless online checkout with cross-MPSP mobile payment. In this embodiment, the acquirer system of the acquirer receives a list request from a user device of the payer, and returns an issuer list to the user device.

FIG. 5 shows a flow chart of the third embodiment enabling seamless online checkout with cross-MPSP mobile payment. In this embodiment, the acquirer system of the acquirer receives a list request from a user device of the payer. Then the acquirer system redirects the user device to the bridging system so that the bridging system may provide an issuer list to the user device.

FIG. 6 is a flow chart of the present invention implemented in iOS, which enables a portable device (e.g., a smartphone) to “scan” the QR code on the screen and pop up a list of issuer mobile apps installed in the portable device.

FIG. 7A-7C show examples of domain matching in iOS. FIG. 7A shows binding an app to the URL of bridging service provider by adding the Associated Domains Entitlement to the app configuration. FIG. 7B shows binding the URL of bridging service provider to the app by uploading a json file to the website of the bridging service provider. FIG. 7C shows and sample code to call a mobile app of an issuer contracted with the bridging service provider (i.e., in the bridging network of the bridging service provider).

FIG. 8A-8D show contents on the phone screen during executing the cross-MPSP mobile payment for online shopping. FIG. 8A shows an example QR code of the bridging service provider (HIVEX). FIG. 8B shows that there are 3 wallet apps installed in the portable device, and FIG. 8C shows that 2 of the 3 wallet apps are contracted with the bridging service provider, and may be selected by the payer. FIG. 8D shows an example where the URL (e.g., QR code or payment link) provided by the online merchant does not contain payment amount, and so the app displays a page for the payer to input the amount.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), graphics processing units (GPUs), etc.

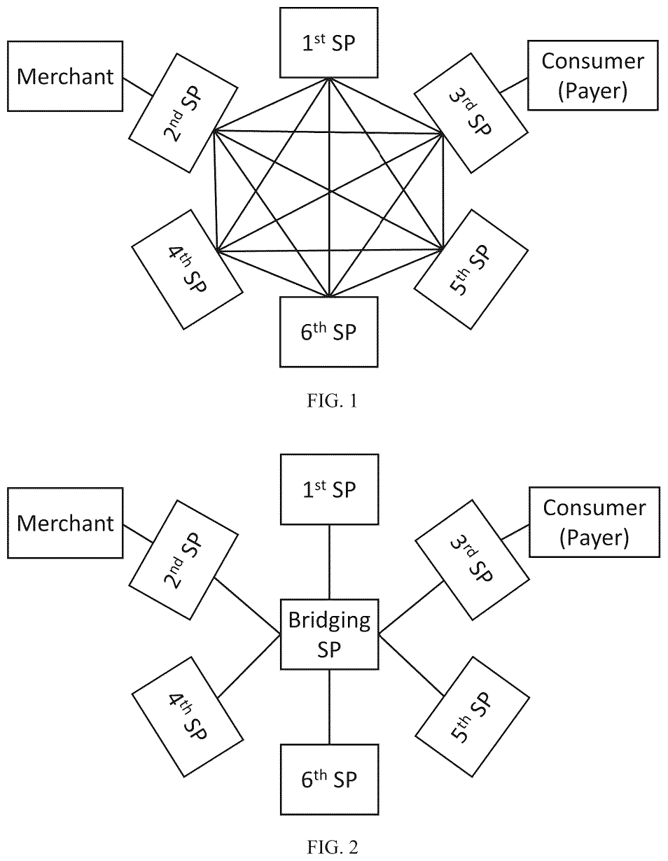

This application relates to a method to facilitate transactions between two mobile payment service providers (MPSPs) with the aid of a bridging service provider. As described above, having bilateral agreements with many MPSPs and amending the systems accordingly is a troublesome and time-consuming task. Take FIG. 1 for example, there are 6 MPSPs (1^{st} SP, 2^{nd} SP, etc.) which would like to form a payment network. In this example, we assume that the merchant is affiliated with 2^{nd} SP and the consumer (the payer) is affiliated with 3^{rd} SP. The MPSP a payer affiliated with is called an “issuer,” and the MPSP a receiver (which is usually a merchant) affiliated with is called an “acquirer.” Therefore, 2^{nd} SP is the acquirer, and 3^{rd} SP is the issuer. If each of the MPSPs establishes bilateral agreements with others, 15 bilateral agreements would be required in this network. And if a new MPSP would like to participate, 6 new bilateral agreements would be required, and each of the MPSPs in the network would need to change its own system to accommodate a new participant. It clearly shows that having bilateral agreements is more and more complicated when the number of participating MPSPs increases.

The above problem can be solved by introducing an intermediate partner called bridging service provider (Bridging SP), as shown in FIG. 2. Every single participating MPSPs contacts with others via the bridging service provider. In this new configuration, each of the MPSPs (besides Bridging SP) only needs to have bilateral agreement and establish connection with Bridging SP. In this example, only 6 bilateral agreements are required to construct such network. And if a new MPSP would like to participate, only one new bilateral agreement (between the Bridging SP and the new participant) would be required.

Two MPSPs can perform cross-MPSP mobile payment with the aid of the intermediate bridging service provider. For merchant-presented mode (MPM) transactions, PCT International Patent Publication No. WO2021/211773 describes methods for issuer MPSP to resolve a code with format of acquirer MPSP to proceed with cross-MPSP transaction. For consumer-presented mode (CPM) transactions, PCT International Patent Publication No. WO2023/132995 describes methods for payer (who is a member of issuer MPSP) to present a code with format of acquirer MPSP to proceed with the transaction. Also, PCT International Patent Publication No. WO2018/022131 describes methods for bridging service provider to facilitate settlement process on blockchain. The above publications are incorporated herein by reference.

The above examples, however, is insufficient to provide a seamless cross-MPSP transaction for online shopping. When using mobile payments in a brick-and-mortar store, the merchant usually provides a merchant code for the consumer to scan, or the merchant scans a consumer code shown on the consumer's portable device. Each of the merchant code and the consumer code may be a 1D code, a 2D code, or with any other code formats. Examples include but not limited to Universal Product Code (UPC), QR codes, PDF417 code, and Data Matrix codes. On the other hand, since an online merchant cannot scan a consumer code presented by a consumer, the merchant usually shows a merchant code on the checkout page for the consumer to scan. Alternatively, the merchant may redirect the consumer to login mobile payment account to pay. If the consumer chooses to pay with an issuer different from the acquirer which the merchant affiliated with, the merchant code or the payment link usually cannot direct the consumer (who is the payer) to the issuer app to pay. If the payer uses a portable device to checkout, he or she might need to take a screenshot first, and use the issuer app to “scan” the merchant code by uploading the screenshot to the app in order to proceed with the payment. And if the online merchant only provides a payment link, it would be even more difficult for the payer to conduct a cross-MPSP transaction. To deal with those problems, the merchant code or payment link provided by the online merchant needs to direct user device of the payer to the app of a selected issuer, so that the payer can use the issuer of his or her choice to conduct a seamless transaction during online shopping.

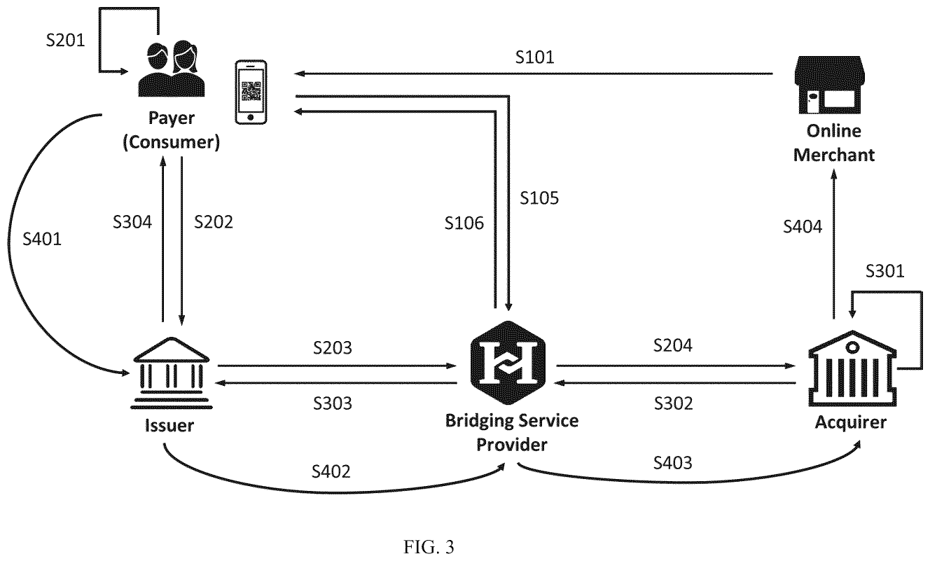

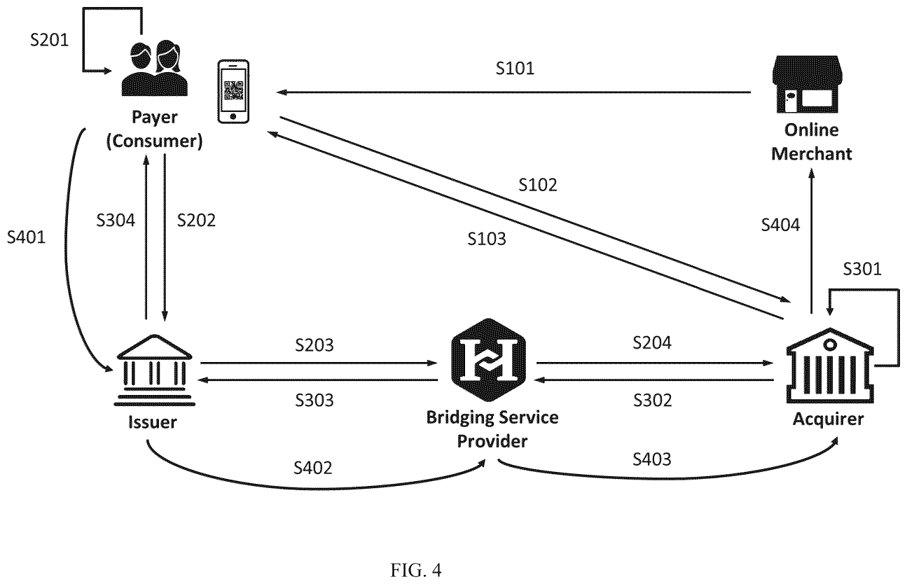

FIGS. 3-5 show three different embodiments to enable seamless online checkout with cross-MPSP mobile payment. In all of the three embodiments, a payer (the consumer) uses a user device to shop online. The user device may be a personal computer, a portable device (e.g., a smartphone or a tablet), or any other suitable devices. After the payer confirms the goods to be purchased, the online merchant may generate a merchant code (e.g., a QR code) or a payment link to proceed with the payment. Here a bridging service provider is involved and acts as an intermediate institution between an issuer and an acquirer. The issuer is the MPSP which the payer affiliated with to deliver the payment, and the acquirer is the MPSP which the merchant affiliated with to collect the payment. The bridging service provider may connect to many MPSPs, as shown in FIG. 2, and in each transaction one of the many MPSPs acts as the issuer and another one of the many MPSPs acts as the acquirer. Theoretically, every MPSP supporting cross-MPSP payment delivery may be selected by the payer as the issuer, and every MPSP supporting cross-MPSP payment collection may be selected by the merchant as the acquirer. However, in practice the online merchant usually selects an MPSP as the acquirer beforehand and embeds related information in the QR code or the payment link. The checkout QR code or the payment link may be or may contain a checkout URL. Based on the agreements, the checkout URL may be recognized by the issuer system and the bridging system as a payment request from the acquirer. To enhance security, the checkout URL may contain an expiration time. Once exceeding the expiration time, processing with the checkout URL may be declined by either the issuer system, the bridging system or the acquirer system.

### First Embodiment: Bridging System Receives List Request and Provides Issuer List

In the first embodiment as shown in FIG. 3, in S101 the payer opens the merchant QR code or payment link in a user device of the payer. If the merchant provides a QR code, the payer may scan the code (using another portable device) or tap on the code (shown on the screen of a portable device) to parse the embedded checkout URL. Alternatively, if the merchant provides a payment link, the payer may simply click or tap on the link to open the checkout URL. In S105, the checkout URL directs the user device to a bridging system (a server) of the bridging service provider for an issuer list. In S106 the bridging system of the bridging service provider then returns the issuer list to the user device of the payer. In the issuer list it may contain one or more available issuers to be selected by the payer. Preferably, it may contain all acceptable issuers which can deliver payment via the bridging service provider to the acquirer. Alternatively, it may also contain only some of the acceptable issuers. For example, the issuer list may only contain issuers available in a specific region, which may be determined by the location of the payer. This feature may, for example, be implemented by collecting the GPS data, the IP number, or other information related to the location of the user device, and then redirecting the payer to a webpage with a region-specific list.

In one example of the first embodiment, the checkout QR code or payment link is generated with format of the bridging service provider. As such, the checkout URL embedded in the checkout QR code or the payment link may direct the user device to the bridging system (the server of the bridging service provider), and the bridging system then may provide a list for the payer's selection. Upon selection, the user device may be instructed to open the app or the login page of the selected issuer to perform following steps of a cross-MPSP transaction. This instruction may be based on the content of the checkout URL. The bridging system may generate such URL and/or QR code when the acquirer requests one and provides merchant identity and payment data to the bridging system. Alternatively, the acquirer may also follow some rules of the bridging service provider and generate a URL or QR code with bridging service provider's format by its own. In both cases, the bridging system may recognize the URL as a payment request from a member of the acquirer.

In S201, after receiving the issuer list, the user device may show the issuer list for the payer to select, and the payer may select a selected issuer based on the list. Next, in S202 the user device may connect to an issuer system (the server) of the selected issuer and provide a delivery request based on the merchant QR code or the payment link. The merchant QR code or the payment link may contain information to instruct the user device to open a mobile app of the selected issuer, or redirect to the login page of the selected issuer to proceed with the payment. Then the user device may generate the delivery request and provide it to the selected issuer. The delivery request requests a delivery transaction to an acquirer system (the acquirer server) of the acquirer, and is generated according to information embedded in the merchant QR code or the payment link based on the bilateral agreement between the selected issuer and the bridging service provider. For example, the issuer system may recognize the checkout URL as a payment request from the acquirer. Although the issuer system may not be able to fully resolve the content (e.g., merchant identity, transaction amount, etc.), it may generate a delivery request and provide the checkout URL in its original format to the bridging system. As such, the bridging system and/or the acquirer system may resolve the remaining part of the checkout URL, and send it back to the issuer system. In S203, after receiving the delivery request from the user device, the issuer system of the selected issuer may recognize the payer, and provide the delivery request along with identity of the payer to the bridging system of the bridging service provider. In S204, the bridging system may add a tag (e.g., a bridging transaction identifier) indicating the identity of the payer and/or the selected issuer to the delivery request, and transmit the delivery request to the acquirer system of the acquirer. Because the merchant QR code or the payment link is provided by the online merchant, the issuer system and/or the bridging system may not be able to completely resolve the merchant QR/payment link. However, based on the bilateral agreements, the issuer system and/or the bridging system may recognize the merchant QR/payment link as a payment request from a member of the acquirer, and forward the unresolved part to the acquirer system to resolve the merchant identity and payment data.

In S301, the acquirer system of the acquirer receives the delivery request from the bridging system. The acquirer system may resolve the URL if there is still some unresolved information, such as merchant identity and payment data. Then in S302 the acquirer system may return a payment request to request a payment from the payer to the online merchant. The payment request may contain information such as acquirer identity, merchant identity, payment data, as well as some information provided in the delivery request (e.g., issuer identity, payer identity, and bridging transaction identifier for this transaction). After receiving the payment request, in S303 the bridging system provides the payment request to the issuer system, and in S304 the issuer system relays the payment request to the user device for the payer to confirm.

In a cross-MPSP transaction (or bridging transaction), the acquirer usually does not recognize the payer, and the issuer usually does not recognize the receiver (usually a merchant). To deal with this problem, the linkage between the payer and the receiver needs to be established by the bridging system. For example, a bridging transaction identifier may be introduced to link the payer of the issuer and the receiver (merchant) of the acquirer. The bridging system of the bridging service provider may generate a bridging transaction identifier for a transaction so that the related transaction information may be connected by the bridging transaction identifier. To enhance privacy protection, the bridging system of the bridging service provider may generate a job identifier (job ID) for each bridging transaction identifier for recording the transaction, which may be stored in a distributed ledger, such as a blockchain. The bridging system may record each transaction with a job ID, a payer virtual wallet (corresponding to payer identity), a receiver virtual wallet (corresponding to receiver identity), an amount and a currency type. Alternatively, the bridging system of the bridging service provider may also generate multiple job IDs for a single bridging transaction identifier, in which case multiple parts of the transaction may be recorded using different job IDs that all correspond to one bridging transaction identifier. The bridging system may record the payer of the selected issuer when receiving the delivery request from the issuer system, link the payer identity with an assigned bridging transaction identifier, and then record the receiver of the acquirer to link it with the same bridging transaction identifier after receiving the payment request from the acquirer system.

In S401, after receiving the payment request, the payer may confirm the payment on the user device, and transmit the confirmation to the issuer system. Then in S402 the issuer system may provide the confirmation to the bridging system, and in S403 the bridging system may provide the confirmation to the acquirer system to proceed with the payment. Lastly, in S404 the acquirer system may send the confirmation to the online merchant, and the merchant may show the confirmation on its webpage to the payer.

### Second Embodiment: Acquirer System Receives List Request and Provides Issuer List

Before bridging transactions between the issuer and the acquirer are available, the acquirer may already have its own payment network using its own QR/URL format. Therefore, the above embodiment requires the online merchant and other receivers of the acquirer to change the format of their QR code from the format of acquirer into the format of the bridging service provider. This causes some problems, since not only the acquirer system but also all related merchant devices need to be changed accordingly. It is desirable for the acquirer and its merchants to retain original QR/URL formats. This can be solved by introducing the second embodiment as shown in FIG. 4.

In the second embodiment, in S101 the payer opens the merchant QR code or payment link in a user device of the payer, just like the first embodiment. However, in S102 the checkout URL directs the user device to the acquirer system, instead of the bridging system, for an issuer list. The bridging system may provide the acquirer system an issuer list in advance, so that the acquirer system can provide it to a payer when requested. The acquirer system may update the issuer list from time to time to ensure the list is consistent with the latest list stored in the bridging service provider. In S103 the acquirer system then returns the issuer list to the user device of the payer. Similar to the first embodiment, the issuer list may contain one or more available issuers to be selected by the payer. Preferably it may contain all acceptable issuers which can deliver payment via the bridging service provider to the acquirer, but it also may contain only part of the full list based on the settings. For example, it may contain only issuers available in a specific region, as described above.

In one example of the second embodiment, the checkout QR code or payment link is generated with format of the acquirer. As such, the checkout URL embedded in the checkout QR code or the payment link may direct the user device to the acquirer system (the server of the acquirer), and the acquirer system then may provide a list for the payer's selection. Upon selection, the user device may be instructed to open the app or to enter the login page of the selected issuer to perform following steps of a cross-MPSP transaction This instruction may be based on the content of the checkout URL. The acquirer system may generate such URL and/or QR code when the merchant requests one and provides its identity and payment data to the acquirer system. Alternatively, the merchant may also follow some rules of the acquirer and generate a URL or QR code with acquirer's format by its own. To proceed with the payment, in both cases the URL is configured to be recognized by the bridging system as a payment request from a member of the acquirer, although the bridging system may not be able to fully resolve the embedded information.

S201 to S404 in the second embodiment after the user device receives the issuer list is analogous to S201 to S404 in the first embodiment. Because the merchant QR code or the payment link is generated by the acquirer system or the online merchant, the issuer system and/or the bridging system may not be able to completely resolve the merchant QR/payment link. However, based on the bilateral agreements, the issuer system and/or the bridging system may recognize the merchant QR/payment link as a payment request from a member of the acquirer, and forward the unresolved part to the acquirer system to resolve the merchant identity and payment data.

### Third Embodiment: Acquirer System Receives List Request, and Bridging System Provides Issuer List

The second embodiment enables the acquirer and its merchants to retain original QR/URL formats. However, in this arrangement each acquirer needs to store a copy of the latest issuer list. If the acquirer can redirect the payer to the bridging system for the issuer list, it can make sure that the payer receives the latest issuer list without the need to update the issuer list frequently to keep consistency, as illustrated in the third embodiment.

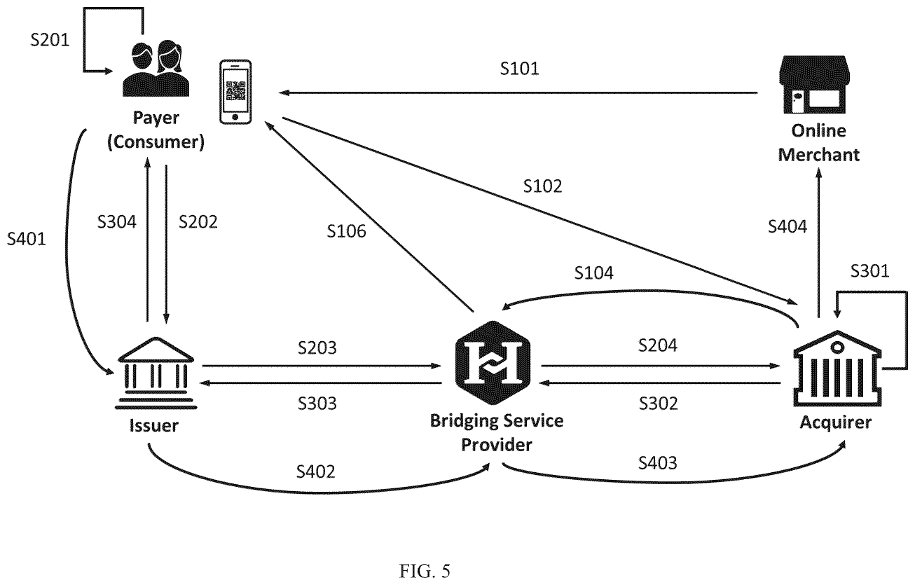

In the third embodiment as shown in FIG. 5, in S101 the payer opens the merchant QR code or payment link in a user device of the payer, just like the first and the second embodiments. And in S102 the checkout URL directs the user device to the acquirer system for an issuer list. Here the system may first check whether the payer has installed a mobile app of the acquirer. If yes, it may call the app of the acquirer directly without selection by the payer. If the payer does not install an app of the acquirer, or the proposal to open the acquirer app is declined, in S104 the acquirer system redirects the user device to the bridging system to retrieve the issuer list. Then in S106 the bridging system provides the issuer list to the user device of the payer. Similar to the first and the second embodiments, the issuer list may contain one or more available issuers to be selected by the payer. Preferably it may contain all acceptable issuers, but it also may contain only part of the full list based on the settings, such as issuers available in a specific region.

In one example of the third embodiment, the checkout QR code or payment link is generated with format of the acquirer. As such, the checkout URL embedded in the checkout QR code or the payment link may direct the user device to the acquirer system (the server of the acquirer). In this example the acquirer system is configured to redirect the user device to the bridging system for the issuer list. The bridging system then provide a list for the payer's selection. Upon selection, the user device may be instructed to open the app or the login page of the selected issuer to perform following steps of a cross-MPSP transaction. This instruction may be based on the content of the checkout URL. The acquirer system may generate such URL and/or QR code when the merchant requests one and provides its identity and payment data to the acquirer system. Alternatively, the merchant may also follow some rules of the acquirer and generate a URL or QR code with acquirer's format by its own. To proceed with the payment, in both cases the URL is configured to be recognized by the bridging system as a payment request from a member of the acquirer, although the bridging system may not be able to fully resolve the embedded information.

S201 to S404 in the third embodiment after the user device receives the issuer list is analogous to S201 to S404 in the first and the second embodiments. Similar to the second embodiment, the issuer system and/or the bridging system may not be able to completely resolve the merchant QR/payment link, but the issuer system and/or the bridging system may recognize the merchant QR/payment link as a payment request from a member of the acquirer, and forward the unresolved part to the acquirer system to resolve the merchant identity and payment data.

### EXAMPLE 1

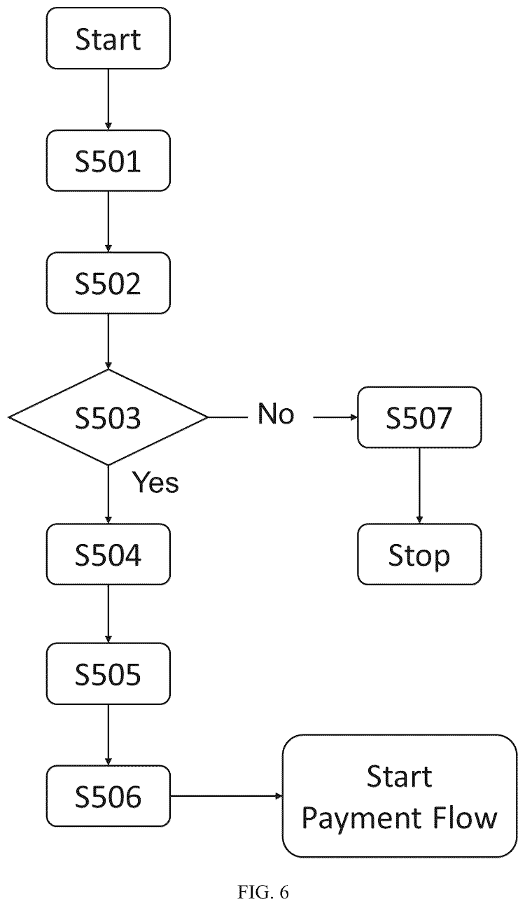

Below example as shown in FIG. 6 describes the flow chart of the present invention implemented in iOS, which enables a portable device (e.g., a smartphone) to “scan” the QR code on the screen and pop up a list of issuer mobile apps installed in the portable device. And with the user's selection, the selected mobile app will automatically parse the merchant QR code to proceed with the payment. In this example, the QR code is with the format of the bridging service provider.

In S501, the online merchant shows a QR code on the screen of the payer's user device (which is a portable device). The QR code is a universal link with the domain name of a bridging service provider. In this example, the bridging service provider is called “HIVEX”, and the universal link of the QR code is with the format of “https://qr.hivex.com/{acquirer_name}/ABCDEFG”, wherein the “{acquirer_name}” indicates the acquirer and the “ABCDEFG” indicates the online merchant.

In S502, the payer delegated the universal link by long pressing (or tapping on) the QR code picture to open the universal link URL by a browser. In S503, after connected to the bridging system of HIVEX (the bridging service provider), the bridging system will provide a list for the portable device to check whether any of the HIVEX contracted MPSP apps is installed on the portable device. If yes, in S504 the portable device will pop up a list showing all installed HIVEX contracted MPSP apps based on the domain name matching (.hivex.com) in the universal link URL (https://qr.hivex.com).

In S505, the payer selects an installed HIVEX contracted MPSP app (e.g. HIVEX-Wallet-App-1), and the selected HIVEX-Wallet-App-1 receives the NSUserActivity (e.g., activityType==NSUserActivityTypeBrowsingWeb.webpageURL==https://qr.hive x.com/{acquirer_name}/ABCDEFG) and redirects to the page based on the path parameter “{acquirer_name}” and “ABCDEFG”. In S506, the selected HIVEX-Wallet-App-1 delegates the universal link QR code content, where the app parses the path parameter components “{acquirer_name}” and “ABCDEFG” from the universal link URL and start the payment flow.

Referring back to S503, the bridging system will check whether any of the HIVEX contracted MPSP apps is installed on the portable device. If no, in S507 the portable device will be redirected to the MPSP app downloading web page for downloading the app. The payer may already have accounts of one or more acceptable issuers. In this case, the payer will be instructed to download one of the apps, and login the selected issuer to proceed with the payment. If the payer is not registered in any of the acceptable issuers, he or she may need to register one first after downloading the app.

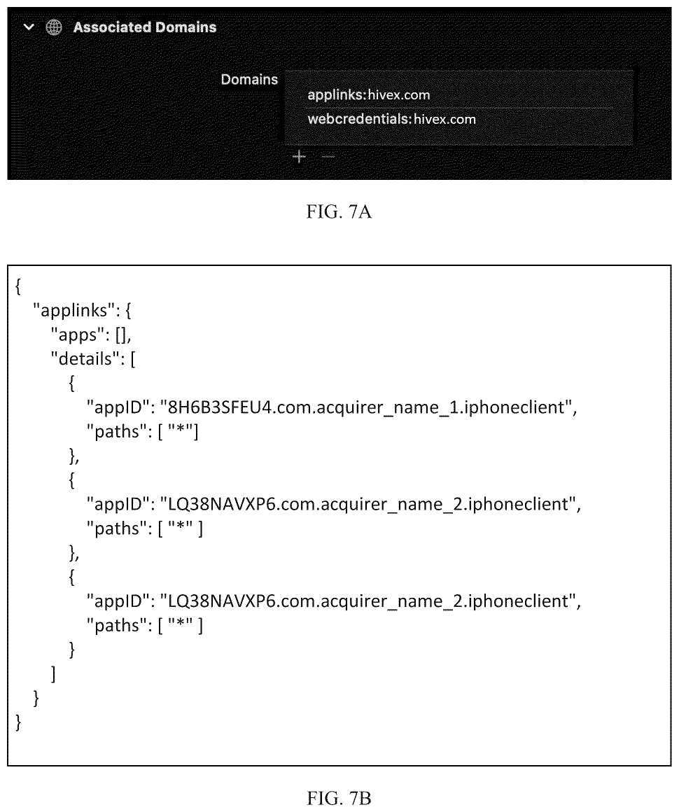

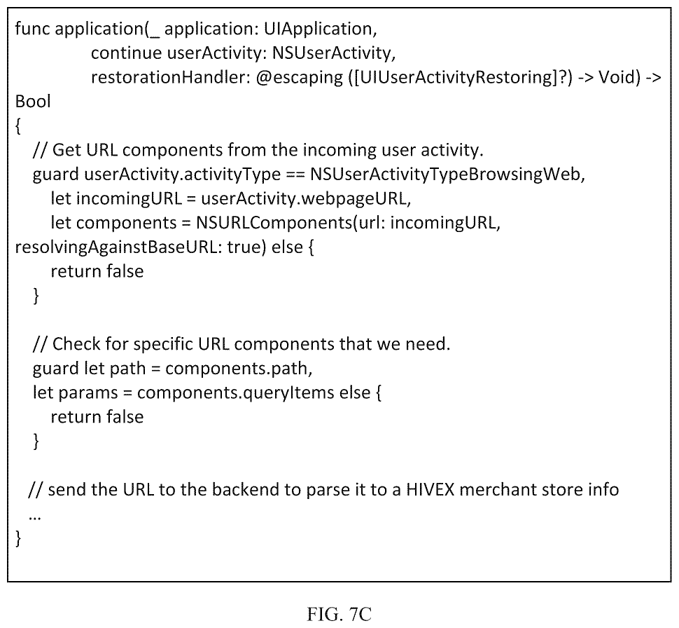

In S504, a two-way association between each issuer app and the HIVEX website is established. The first direction is to bind the app to the HIVEX URL, and the second direction is to bind the HIVEX URL to the app. The two-way association specifies the URLs that the app handles. To bind an app to the HIVEX URL, the Associated Domains Entitlement (e.g., applinks:*.hivex.com) is added to the app configuration, as shown in FIG. 7A. To bind the HIVEX URL to the app, the example json file as shown in FIG. 7B is uploaded to the HIVEX website at “https://qr.hivex.com/.well-known/apple-app-site-association”.

To call a HIVEX contracted wallet app (an issuer app), the system then updates the HIVEX contracted wallet app delegate to respond when it receives an NSUserActivity object with the activity Type set to “NSUserActivityTypeBrowsingWeb”. The sample code is shown in FIG. 7C.

### EXAMPLE 2

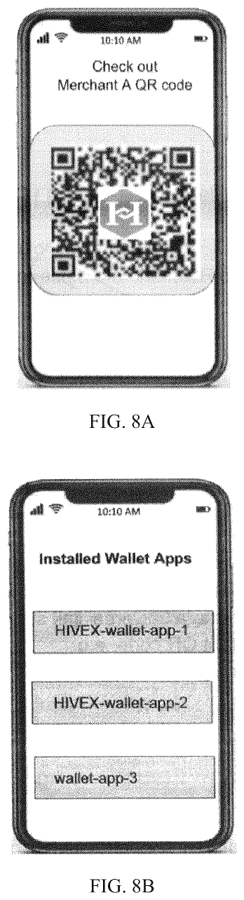

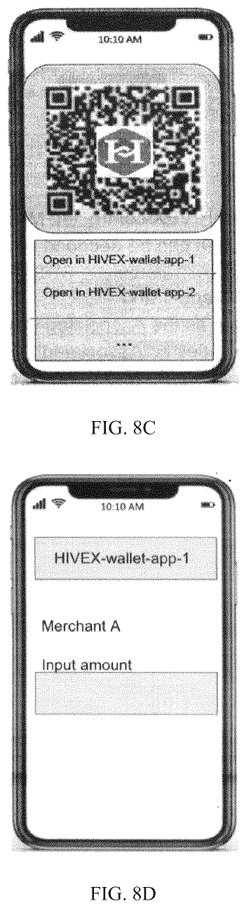

The following is an example showing the invention implemented on iOS. During a web checkout, the payer may select one of HIVEX (which is the bridging service provider) contracted merchant acquirer checkout methods. After the payer clicks the merchant acquirer checkout method button (e.g., acquirer_name_1), the user receives a universal link string with the prefix “https://***.hivex.com/{acquirer_name_1}/***” as the HIVEX merchant QR code (e.g. https://qr.hivex.com/{acquirer_name_1}/ABCDEFG), and shows it on the user's phone screen. The universal link string (the associated HIVEX merchant QR code) may be generated after the payer requests a checkout payment, or it may be generated beforehand. In the first case, after the payer clicks the HIVEX checkout option, the merchant store may call the HIVEX system to request a universal link string and shows the responded string as the associated HIVEX merchant QR code on the screen of payer's portable device. In the second case, the HIVEX system has already sent back the universal link string before the payer clicks the HIVEX checkout option so that it may directly show to the payer as the associated HIVEX merchant QR code on the screen of payer's portable device, as shown in FIG. 8A.

Some or all HIVEX contracted MPSPs have their own merchants and these merchants also have been registered into the HIVEX system. When the HIVEX system generates the merchant's QR code every time, the merchant's QR code may be linked to the target merchant on the MPSP of acquirer side. In this case, the merchant's QR code may be decoded by the HIVEX system through the request sent from the HIVEX contracted user wallet apps on the MPSP of issuer side (issuer apps). A wallet app provided by any of the HIVEX contracted MPSP is a HIVEX contracted wallet app.

From HIVEX's perspective, it is MPSPs instead of users (e.g., payers and merchants) of those MPSP who join the HIVEX network. It is a delivery/receiving of funds between different MPSP accounts on the HIVEX network when a cross-MPSP transaction happens. To enable it, the exposure limit, which defines the funds of a currency received from the peer MPSP, may be set up during the provisioning on the HIVEX network.

All HIVEX contracted user wallet apps, e.g. HIVEX-wallet-app-1 and HIVEX-wallet-app-2, have added the “applinks:*.hivex.com” as the Associated Domains Entitlement in the apps. At the same time, the HIVEX includes an Associated Domain File on the HIVEX website “https://qr.hivex.com/.well-known/apple-app-site-association” with respect to these app identifiers (The appIDs and apps keys specify the application identifiers for the apps that are available for use on this website along with their service type. The appID is with the format of: “<Application Identifier Prefix>.<Bundle Identifier>”). The method to establish two-way association is described in Example 1 above.

The payer may long press or tap on the HIVEX merchant QR code on the screen, and then the portable device will provide a menu based on the domain name in the universal link “*.hivex.com”. The content of the menu will depend on how many HIVEX contracted wallet apps (issuer apps) the payer installed. For example, if the payer installs 3 HIVEX contracted wallet apps, the menu will show 3 apps for the payer to select. In one embodiment, the long-pressing QR gesture is supported by the UIKit framework, which provides the required infrastructure for iOS apps.

If the payer has installed multiple wallet apps and some of them are HIVEX contracted wallet apps, it will list all installed HIVEX contracted wallet apps. For example, if there are 3 wallet apps (as shown in FIG. 8B), HIVEX-wallet-app-1 (HIVEX contracted wallet app), HIVEX-wallet-app-2 (HIVEX contracted wallet app), and wallet-app-3 (non HIVEX contracted wallet app), then only HIVEX-wallet-app-1 and HIVEX-wallet-app-2 will be listed, as shown in FIG. 8C.

The payer then selects one of the HIVEX contracted wallet apps, HIVEX-wallet-app-1, and it jumps to open the HIVEX-wallet-app-1 based on the registered HIVEX domain name in the universal link “https://qr.hivex.com” in the Associated Domains Entitlements.

In the steps of selecting a HIVEX contracted wallet app, an alternative way is to establish a preference list before redirecting to HIVEX contracted wallet apps. This may be done by setting an order of the dictionaries in the array, one dictionary per app that the HIVEX domain name supports. It determines the order of the preference list that the system follows when looking for a match, so one can specify an app to handle a particular part of the path in the universal link. In this way, the universal link brings the user to a HIVEX contracted wallet app according to the preference list and the availability of the apps on the portable device.

In some cases, there is no HIVEX contracted wallet app available on the portable device of the payer. If this happens, the universal link may redirect to HIVEX's webpage and instruct the user to install one of the HIVEX contracted wallet apps in order to proceed with the payment.

After being selected, The HIVEX-wallet-app-1 may receive the universal link URL “https://qr.hivex.com/{acquirer_name_1}/ABCDEFG”, and then extract the path parameters “{acquirer_name_1}” and “ABCDEFG” from it to redirect the page to let the payer input the payment amount after auto decoding the HIVEX merchant QR code content, as shown in FIG. 8D.

Alternatively, the online merchant may call the HIVEX system to generate a QR code embedded with the currency and payment amount. In this way, the payer does not need to input the amount after auto decoding the HIVEX merchant QR code content, thus avoiding the possibility that the payer enters an incorrect payment amount, and facilitating merchant's payment confirmation.

It depends on the type of the QR code whether entering a payment amount is required. If the QR code is an embedded QR code, which links to both the predetermined amount info and the merchant store info in the HIVEX system, after the QR code was resolved, the app would not ask the payer to input the amount info. If the QR code is a regular QR code, which only links to the merchant store info in the HIVEX system, after the QR code was resolved, the app would ask the payer to input the amount info.

The above example is to be executed in iOS. However, in other operating systems, this invention can also be implemented. For example, when using a portable device with an Android system, the steps can also be implemented through the Android App Links. The Android App Links are the functionally similar to the universal link in iOS. Functionally, Universal Links/Android App Links allow a single link to either open an app or open a webpage on the browser. Android App Links (sometimes also referred to as “universal links”) are HTTP URLs available on Android 6.0 and higher, which may bring users directly to Android apps. It contains the autoVerify attribute that allows an app to designate itself as a given type of link.

In addition, the bridging service provider (e.g., HIVEX) system may also provide a webpage listing the issuers to be selected by the payer before redirecting the user device to Universal Links/Android App Links to open specific apps. This may enable the bridging service provider to perform various functions such as promoting specific issuers, displaying only issuers in specific regions, and displaying the issuer list in a predetermined order.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A method for online checkout between an issuer system of a selected issuer and an acquirer system of an acquirer, comprising:
providing, by a bridging system of a bridging service provider, an issuer list comprising one or more available issuers to a user device of a payer; and
receiving, by the bridging system, a delivery request from the issuer system of the selected issuer selected from the one or more available issuers; wherein:
the delivery request is generated based on a checkout URL;
the delivery request requests a delivery transaction to the acquirer system of the acquirer; and
the selected issuer is different from the acquirer.

2. The method of claim 1, before providing the issuer list comprising one or more available issuers further comprising:
receiving, by the bridging system, a list request from the user device of the payer.

3. The method of claim 2, wherein the list request is redirected from the acquirer system before receiving by the bridging system.

4. The method of claim 1, wherein the user device is a portable device, and the checkout URL is configured to open issuer apps of the one or more available issuers installed on the portable device.

5. The method of claim 2, wherein the checkout URL is configured to direct the user device to the bridging system.

6. The method of claim 5, wherein the checkout URL is embedded in a QR code of the bridging service provider.

7. The method of claim 3, wherein the checkout URL is configured to direct the user device to the acquirer system.

8. The method of claim 7, wherein the checkout URL is embedded in a QR code of the acquirer.

9. The method of claim 1, after receiving the delivery request from the issuer system further comprising:
providing, by the bridging system, the delivery request to the acquirer system;
receiving, by the bridging system, a payment request from the acquirer system;
providing, by the bridging system, the payment request to the issuer system;
receiving, by the bridging system, a payment confirmation confirming the payment request from the issuer system; and
providing, by the bridging system, the payment confirmation to the acquirer system.

10. A method for online checkout between an issuer system of a selected issuer and an acquirer system of an acquirer, comprising:
receiving, by a user device of a payer, an issuer list comprising one or more available issuers; and
providing, by the user device of the payer, a delivery request to the issuer system of the selected issuer selected from the one or more available issuers; wherein:
the delivery request is generated based on a checkout URL;
the delivery request requests a delivery transaction to the acquirer system of the acquirer; and
the selected issuer is different from the acquirer.

11. The method of claim 10, before receiving the issuer list comprising one or more available issuers further comprising:
providing a list request by the user device.

12. The method of claim 10, wherein the user device is a portable device, and the checkout URL is configured to open issuer apps of the one or more available issuers installed on the portable device.

13. The method of claim 11, wherein the list request is provided to the acquirer system.

14. The method of claim 13, wherein the issuer list is received from the acquirer system.

15. The method of claim 13, wherein the issuer list is received from a bridging system of a bridging service provider.

16. The method of claim 11, wherein the list request is provided to a bridging system of a bridging service provider, and the issuer list is received from the bridging system.

17. The method of claim 15, wherein the list request is redirected from the acquirer system to the bridging system.

18. The method of claim 16, wherein the checkout URL is configured to direct the user device to the bridging system.

19. The method of claim 18, wherein the checkout URL is embedded in a QR code of the bridging service provider.

20. The method of claim 13, wherein the checkout URL is configured to direct the user device to the acquirer system.

21. The method of claim 20, wherein the checkout URL is embedded in a QR code of the acquirer.

22. The method of claim 10, after providing the delivery request to the issuer system further comprising:
receiving, by the user device, a payment request from the issuer system; and
providing, by the user device, a payment confirmation confirming the payment request to the issuer system.

23. A method for online checkout between an issuer system of a selected issuer and an acquirer system of an acquirer, comprising:
receiving, by the issuer system of the selected issuer, a delivery request from a user device of a payer; and
providing, by the issuer system of the selected issuer, the delivery request to a bridging system of a bridging service provider; wherein:
the delivery request is generated based on a checkout URL;
the delivery request requests a delivery transaction to the acquirer system of the acquirer; and
the selected issuer is different from the acquirer.

24. The method of claim 23, wherein the issuer system does not resolve a payment request embedded in the checkout URL.

25. The method of claim 24, wherein the checkout URL is resolved by the bridging system or the acquirer system.

26. The method of claim 23, after providing the delivery request to the bridging system further comprising:
receiving, by the issuer system, a payment request from the bridging system;
providing, by the issuer system, the payment request to the user device;
receiving, by the issuer system, a payment confirmation confirming the payment request from the user device; and
providing, by the issuer system, the payment confirmation to the bridging system.

27. A method for online checkout between an issuer system of a selected issuer and an acquirer system of an acquirer, comprising:
receiving, by an acquirer system of the acquirer, a list request from a user device of a payer;
redirecting, by the acquirer system, the user device to a bridging system of a bridging service provider, so that the bridging system provides providing an issuer list comprising one or more available issuers to the user device; and
receiving, by the acquirer system, a delivery request from an issuer system of the selected issuer via the bridging system, the selected issuer is selected from the one or more available issuers; wherein:
the delivery request is generated based on a checkout URL;
the delivery request requests a transaction to the acquirer system of the acquirer; and
the selected issuer is different from the acquirer.

28. The method of claim 27, wherein the user device is a portable device, and the checkout URL is configured to open issuer apps of the one or more available issuers installed on the portable device.

29. The method of claim 27, wherein the checkout URL directs the user device to the acquirer system.

30. The method of claim 29, wherein the checkout URL is embedded in a QR code of the acquirer.

31. The method of claim 27, after receiving the delivery request from the issuer system further comprising:
providing, by the acquirer system, a payment request to the bridging system; and
receiving, by the acquirer system, a payment confirmation confirming the payment request from the bridging system.

32. A method for online checkout between an issuer system of a selected issuer and an acquirer system of an acquirer, comprising:
receiving, by an acquirer system of the acquirer, a list request from a user device of a payer;
providing, by the acquirer system, an issuer list comprising one or more available issuers to the user device of the payer; and
receiving, by the acquirer system, a delivery request from an issuer system of the selected issuer via the bridging system, the selected issuer is selected from the one or more available issuers; wherein:
the delivery request is generated based on a checkout URL;
the delivery request requests a transaction to the acquirer system of the acquirer; and
the selected issuer is different from the acquirer.

33. The method of claim 32, wherein the user device is a portable device, and the checkout URL is configured to open issuer apps of the one or more available issuers installed on the portable device.

34. The method of claim 32, wherein the checkout URL directs the user device to the acquirer system.

35. The method of claim 34, wherein the checkout URL is embedded in a QR code of the acquirer.

36. The method of claim 32, after receiving the delivery request from the issuer system further comprising:
providing, by the acquirer system, a payment request to the bridging system; and
receiving, by the acquirer system, a payment confirmation confirming the payment request from the bridging system.
